(19) United States
(12) Patent Application Publication
(10) Pub. No.: US 2020/0394669 A1
(43) Pub. Date: Dec. 17, 2020

(54) METHOD AND SYSTEM FOR ANALYZING PURCHASES OF SERVICE AND SUPPLIER MANAGEMENT

(71) Applicant: Premier Healthcare Alliance, LP, Charlotte, NC (US)

(72) Inventors: Mickey Meehan, Walnut Creek, CA (US); Bill Sambrone, Walnut Creek, CA (US); Chris Gormley, Guilford, CT (US)

(73) Assignee: Premier Healthcare Alliance, LP, Charlotte, NC (US)

(21) Appl. No.: 16/899,766

(22) Filed: Jun. 12, 2020

Related U.S. Application Data
(60) Provisional application No. 62/861,245, filed on Jun. 13, 2019.

(51) Int. Cl. G06Q 30/02; G06N 7/00; G06F 3/0482

(52) U.S. Cl. CPC G06Q 30/0206; G06F 3/0482; G06N 7/005

(57) ABSTRACT

The present invention relates to system, method and computer program product for processing resource transfers and constructing resource values. The system comprises a computer-executable platform comprising a resource value construction module that is structured to access a data storage module and determine a resource value offer of the resource. The system further comprises a Bayesian network connected to the computer-executable platform. Moreover, the system comprises a user interface connected to the Bayesian network, the user interface comprising: a selection module that is structured to receive a user section of an indication of resource; and a management module that allows the user to manage the information of the resources via the user interface.

### CROSS-REFERENCE TO PRIORITY APPLICATION

This application claims priority to and the benefit of U.S. Provisional Patent Application Ser. No. 62/861,245, filed Jun. 13, 2019 entitled “Method and System for analyzing purchases of service and supplier management,” which is hereby incorporated by reference in its entirety.

### FIELD OF THE DISCLOSURE

The present invention relates to methods, systems, and computer program products for processing resource transfers and constructing resource values. In some instances, the invention involves processing resource transfers by analyzing purchased services, and more particularly involves constructing resource values by predicting the prices of the transactions based on the input of the user.

### BACKGROUND

Source entities may comprise a variety of resources such as components, items, devices, services, etc. Typically, attributes of a resource are variable and fluctuate over time. Specifically, the resource values of resources vary over time, in an irregular manner. For instance, a current resource value of a resource at a first time may be distinct from a future resource value at a second time at which the resource is processed. A recipient resource system associated with receiving the resource transfer from the source entity is typically not able to ascertain resource values and cannot determine an optimal time for initiating the resource transfer at which time the resource value will be between a predetermined threshold. Accordingly, there is a need for a system structured for processing resource transfers and constructing resource values.

All referenced patents, applications, and literature are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply. The disclosed embodiments may seek to satisfy one or more of the above-mentioned desires. Although the present embodiments may obviate one or more of the above-mentioned desires, it should be understood that some aspects of the embodiments might not necessarily obviate them.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention provide a method, system and computer program product for processing resource transfers and constructing resource values, and analyzing information of resources. In some embodiments, the system comprises a computer-executable platform comprising a resource value construction module that is structured to access a data storage module and determine a resource value offer of the resource. The system further comprises a Bayesian network connected to the computer-executable platform. Moreover, the system comprises a user interface connected to the Bayesian network, the user interface comprising: a selection module that is structured to receive a user section of an indication of resource; and a management module that allows the user to manage the information of the resources via the user interface.

In some embodiments, or in combination with any of the previous embodiments, the data storage module comprises a supplier bid data which includes previous resource value offers which a plurality of source entities have offered to provide resources.

In some embodiments, or in combination with any of the previous embodiments, the data storage module comprises a contract data module which includes contract values, spends, and terms.

In some embodiments, or in combination with any of the previous embodiments, the data storage module comprises an organization report data which includes reports from organizations, wherein the reports comprise current resource value offers with the similar resource level.

In some embodiments, or in combination with any of the previous embodiments, the data storage module comprises prior purchase date, which includes the previous resource value offers of the resources that were provided by a plurality of source entities.

In some embodiments, or in combination with any of the previous embodiments, the selection module is structured to receive a customized resource value offer from the user, which is analyzed by the predictive module.

In some embodiments, or in combination with any of the previous embodiments, the resource value construction module comprises a resource value construction module that is structured to determine a prediction for a future direction of the resource value offer of the resource.

In some embodiments, or in combination with any of the previous embodiments, the resource value construction module comprises a predictive analyzer module that analyzes customized resource value offers and the future direction of the resource value offers.

In some embodiments, or in combination with any of the previous embodiments, the resource value construction module comprises a predictive advisor module that analyzes the previous resource value offers and the resource value offers so that the user can decide whether to accept the resource value offers from the source entities or the organizations.

Some embodiments of the invention are directed to a method performed by a computer for providing pricing information for resources. The method comprises the steps of: providing a computer-executable platform having a resource value construction module and a data storage module structured to provide a supplier bid data, a contract data, an organization data, and a prior purchase data to the resource value construction module; providing a user interface having a selection module that is structured to receive user selections of indications of the resources; receiving the selected indications of the resources from the selection module and transmitting the selected indications to the resource value construction module, and analyzing the selected indications of the resources to generate resource value offers of the resources.

According to some aspects of the invention, in a general implementation, a computer system for analyzing information of services comprises a computer-executable platform comprising a predictive price module that accesses a data storage module and determines an offer price of the service; a Bayesian network connected to the computer-executable platform; and a user interface connected to the Bayesian network; wherein the user interface comprises a selection module that provides the user to select an indication of service and a management module that provides the user to manage the information of the services.

In another aspect combinable with the general implementation, at least one of the data storage module comprises a supplier bid data which includes previous offer prices which a plurality of suppliers have offered to provide services.

In another aspect combinable with the general implementation, at least one of the data storage module comprises a contract data module which includes contract values, spends, and terms.

In another aspect combinable with the general implementation, at least one of the data storage module comprises an organization report data which includes reports from organizations, wherein the reports comprise current price offers with the similar service level.

In another aspect combinable with the general implementation, at least one of the data storage module comprises prior purchase date, which includes the previous offer prices of the services that provide by a plurality of suppliers or organizations.

In another aspect combinable with the general implementation, at least one of the selection module can provide the user to input customized offer price, which is analyzed by the predictive module.

In another aspect combinable with the general implementation, at least one of the predictive price module comprises a predictive price module that determined a prediction for a future direction of the offer price of the service.

In another aspect combinable with the general implementation, at least one of the predictive price module comprises a predictive analyzed module that analyzes customized offer prices and the future direction of the offer prices.

In another aspect combinable with the general implementation, at least one of the predictive price module comprises a predictive advisor module that analyzes the previous offer prices and the offer prices so that the user can decide whether to accept the offer prices from the suppliers or the organizations.

Another aspect of the embodiment is directed to methods of providing pricing information for services, the method comprising: providing a computer-executable platform having a predictive price module and a data storage module to provide a supplier bid data, a contract data, an organization data, and a prior purchase data to the predictive price module; providing a user interface having a selection module that provides the user to select an indication of the services; providing selected indications of the services by the selection module and receiving the selected indications by the predictive price module; and analyzing the selected indications of the services to generate offer prices of the services.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above and below as acting in certain combinations and even initially claimed as such, one or more features from a claimed combination can in some cases be excised from the combination, and the claimed combination may be directed to a subcombination or variation of a subcombination.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates a processing system environment, in accordance with one embodiment of the invention.

FIG. 2 illustrates a schematic representation of system components for processing resource transfers and constructing resource values, in accordance with one embodiment of the invention.

FIG. 3 illustrates a high level process flow for a method and process for processing resource transfers and constructing resource values, in accordance with one embodiment of the invention.

FIG. 4 illustrates a schematic representation of an interface for processing resource transfers and constructing resource values, e.g., for analyzing purchases of services and supplier management according to the aspect of the embodiment, in accordance with one embodiment of the invention.

It should be noted that the drawing figures may be in simplified form and might not be to precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In some embodiments, an “source entity” or “supplier entity” as used herein may be any institution associated with providing resources. The resources may comprise components, items, devices, services, and/or the like. Each resource may comprise one or more resource attributes such as a resource value. A resource value of a resource may refer to a cost, price and/o the like of the resource. In some embodiments, the “source entity” or “supplier entity” is a supplier associated with providing medical resources such as medical devices, medical equipment, and/or the like. That said, the source entity or supplier entity may be any institution, group, association, establishment, company, union, manufacturer, supplier, seller, and/or the like.

In some embodiments, an “recipient entity” or “buyer entity” as used herein may be any institution associated with receiving/obtaining resources from the source/supplier entity. The source/supplier entity may transfer the resource to the recipient/buyer entity. This resource transfer may also be referred to as a purchase, such that a resource value may be transmitted from the recipient/buyer entity to the source/supplier entity, in exchange for the resource transfer from the source/supplier entity to the recipient/buyer entity. That said, the recipient/buyer entity may be any institution, group, association, establishment, company, union, manufacturer, buyer, intermediate seller, and/or the like.

In some embodiments, a “user” as used herein may be any individual or institution associated with receiving resources from the source/supplier entity, e.g., via a resource transfer therebetween. In some embodiments, the “user” is also referred to as a customer of the source/supplier entity (e.g., a supplier). In this regard, the user may be associated with the recipient/buyer entity.

As alluded to earlier, source entities may comprise a variety of resources such as components, items, devices, services, etc. Typically, attributes of a resource are variable and fluctuate over time. Specifically, the resource values of resources vary over time, in an irregular manner. For instance, a current resource value of a resource at a first time may be distinct from a future resource value at a second time at which the resource is processed. A recipient resource system associated with receiving the resource transfer from the source entity is typically not able to ascertain resource values and cannot determine an optimal time for initiating the resource transfer at which time the resource value will be between a predetermined threshold. Here, many potential recipients/buyers may face difficult decisions when attempting to determine whether acquiring particular resource (e.g., one or more items or services) under current conditions is desirable or optimal based on their goals. In other words, the recipients/buyers may delay the acquisition of the resource. For example, when the recipients/buyers desire to obtain the resource at the lowest price (e.g., below a predetermined threshold) before some future date, and the service is currently offered by a source/supplier for a current resource value (e.g., price), the potential recipients/buyers need to evaluate whether accepting the current resource value (e.g., price) is more advantageous than the potential benefits and costs associated with the market prices, or waiting to see if the resource (e.g., item or service) will continue to be available and will be later offered at a lower resource value (e.g., price) before the future date.

Accordingly, there is a need for a system structured for processing resource transfers indicated by the users to determine optimal time for initiating the resource transfer at which time the resource value will be between a predetermined threshold. Here, it would be beneficial to be able to predict future resource value (e.g., pricing) information for the resource (e.g., one or more items or services) and compare the market prices of the resource (e.g., one or more items or services) with the current prices of the resource, as doing so would enable recipients/buyers and/or intermediate sellers to make better acquisition-related decisions.

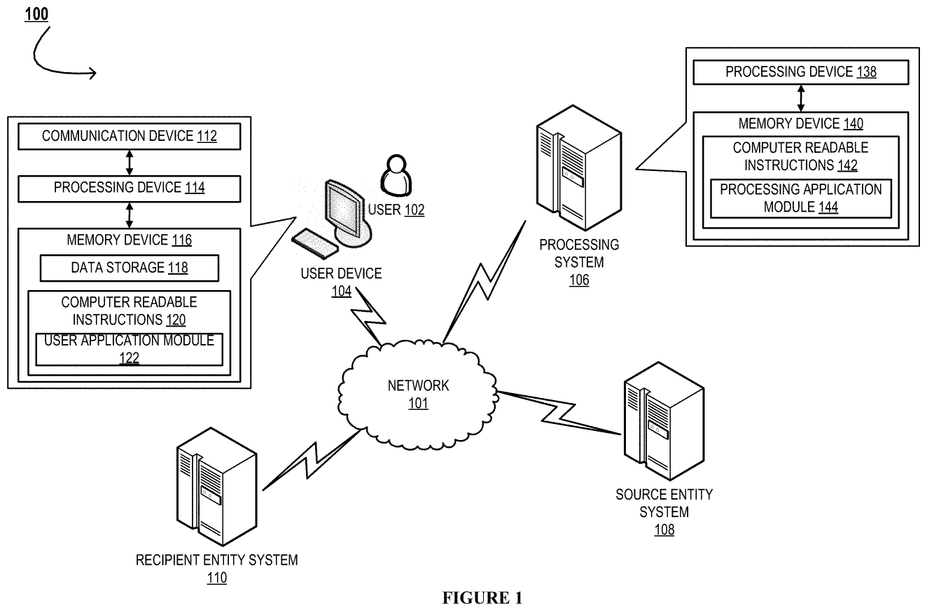

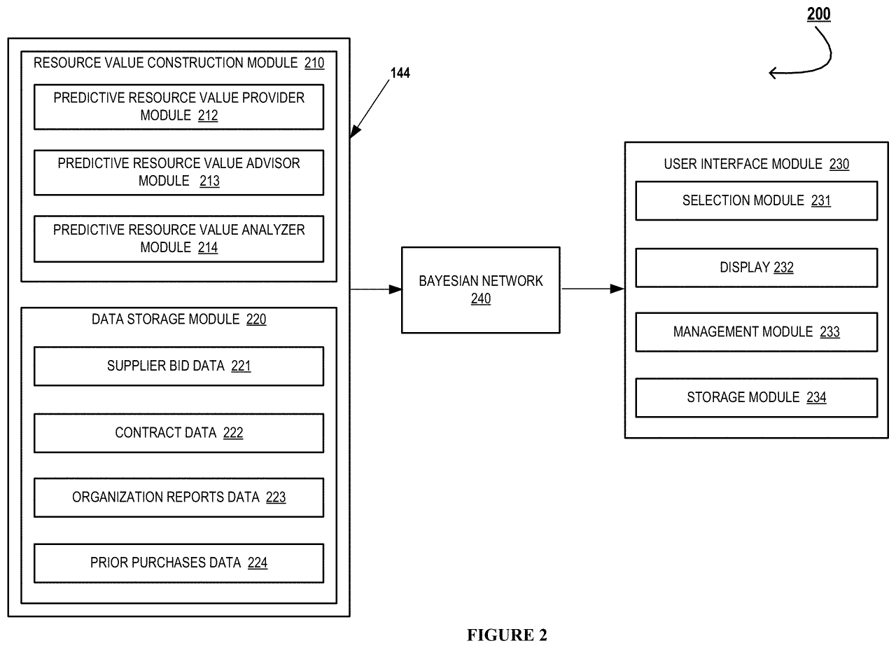

FIG. 1 illustrates a processing system environment 100, in accordance with one embodiment of the invention. As illustrated in FIG. 1, a processing system 106 is operatively coupled, via a network 101 to a user system/device 104 associated with a user 102, a source entity system 108 (also referred to as a source entity system 108) associated with the source/supplier entity, and/or a recipient entity system 110 (also referred to as a buyer system 110) associated with the recipient/buyer entity. The processing system 106 may also be referred to as a “computing system”, “computing device,” “server” or “system”. The processing system 106 typically comprises at least one processing device 138 that is structured to perform one or more of the steps/functions associated with for processing resource transfers and constructing resource values described herein (e.g., as described below with respect to FIGS. 2-4). Typically, the at least one processing device 138 is structured to perform one or more of the steps/functions described herein based on executing computer readable instructions/code 142 of a processing application module 144 stored on a memory device 140. The processing system 106 may be in operative communication with and may transmit signals to and receive signals from, the user device 140, the recipient entity system 110 and/or the source entity system 108 associated with the supplier entity. The processing system 106, and the processing application module 144 in particular, is structured for processing resource transfers and constructing resource values, e.g., based on executing computer-readable instructions 142. Specifically, the processing system 106, and the processing application module 144 in particular is structured for processing resource transfers by analyzing purchased services, and more particularly constructing resource values by predicting the prices of the transactions based on the input of the user. FIG. 1 illustrates only one example of an embodiment of the system environment 100, and it will be appreciated that in other embodiments one or more of the systems, devices, or servers may be combined into a single system, device, or server, or be made up of multiple systems, devices, or servers.

The network 101 may be a global area network (GAN), such as the Internet, a wide area network (WAN), a local area network (LAN), near field communication network, audio/radio communication network, ultra-high frequency wireless communication network, or any other type of network or combination of networks. The network 101 may provide for wireline, wireless, or a combination wireline and wireless communication between devices on the network 101.

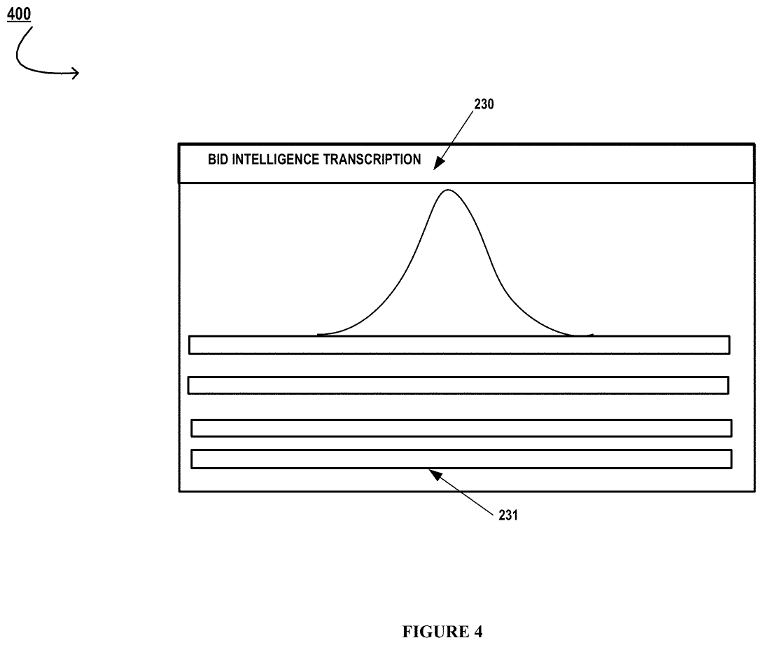

The user device 104 may comprise a communication device 112, a processing device 114, and a memory device 116. The memory device 116 may comprise a data storage 118, along with computer readable instructions 120 for a user application 122. The processing system 106 may transmit control signals/instructions to the user device 104, via the network 101, to cause the user application 122 to display a resource interface (e.g., the interface illustrated in FIG. 4) on a display device/component of the user device 104.

FIG. 2 illustrates a schematic representation 200 of system components for processing resource transfers and constructing resource values, in accordance with one embodiment of the invention. Specifically, FIG. 2 generally depicts a computer system and its components associated with the processing application module 144 of the processing system 106, which is structured for analyzing purchases of services and supplier management in accordance with one of the disclosed embodiments.

The processing application module 144 may also be referred to as a computer-executable platform. The processing application module 144 may comprise a resource value construction module 210 also referred to as a predictive price module and a data storage module 220, which are in operative communication with each other. The resource value construction module 210 is structed to access a data storage module 220, so as to determine a resource value (e.g., offer price) of a resource (e.g., item or service). As illustrated by FIG. 2, the resource value construction module 210 comprises a predictive resource value provider module 212 (also referred to as a predictive price provider module 212), a predictive resource value advisor module 213 (also referred to as a predictive price advisor module), and a predictive resource value analyzer module 214 (also referred to as a predictive price analyzer module 214).

As illustrated by FIG. 2, the data storage module 220 comprises a supplier bid data component 221, a contract data component 222, an organization reports data component 223, and a prior purchase data component 224. Typically, the supplier bid data 221 comprises previous resource value offers (e.g., previous offer prices) which a plurality of source/supplier entities have previously offered to provide resources (e.g., items or services). The contract data 222 typically comprises contract values, spends, terms, and/or the like. The organization reports data 223 typically comprises reports from organizations. These reports comprise current resource value offers (e.g., current price offers) with a similar resource/service level. The prior purchases data 224 typically comprises the previous resource values (e.g., previous purchase prices, offer prices, etc.) of the services provided by a plurality of source/supplier entities or organizations, and/or previous resource values or purchase prices of resources obtained by the recipient/buyer entity from the source/supplier entities.

In one embodiment, processing application module 144 is operatively coupled with a user interface module 230 of the user device 104, via a Bayesian network 140. In some embodiments, the a Bayesian network 140 is a part of the network 101 of FIG. 1. The user interface module 230 comprises a selection module 231, a display 232, a management module 233 and a storage module 234. The selection module 231 is structured for facilitating the user selection of an indication of resource (e.g., service). A representation of the interface of the selection module is illustrated in FIG. 4. The management module 233 that allows the user to view and manage the information regarding the resources (e.g., services).

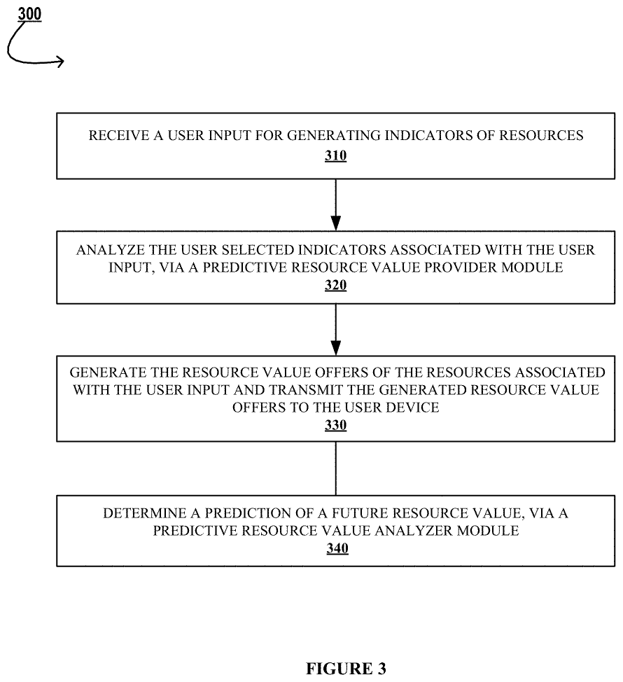

FIG. 3 illustrates a high level process flow 300 for a method and process for processing resource transfers and constructing resource values, in accordance with one embodiment of the invention. As indicated previously, some or all of the steps of the process flow 300 may be performed by the system 106 (“the system”) in conjunction with the processing application module 144 and the user interface module, via the Bayesian network 140, as described with respect to FIG. 2.

As illustrated by block 310 of FIG. 3, the system may receive a user input for generating indicators of resources. The user input may comprise customized resource value offers (e.g., customized offer prices), e.g., resource value offers (e.g., customized offer prices) received from source/supplier entities. Here, the user can input customized offer prices into the selection module 231 to generate selected indications of the resources (e.g., services). The user selected indications are then transmitted to the processing application module 144 via the Bayesian network 140. Here, the selected indications may comprise categories, levels, yearly usage, service locations, states, and turn-around time of the services.

In response, the system may analyze the user selected indicators associated with the user input, via the predictive resource value provider module 212 to generate the resource value offers (e.g., offer prices) of the resources (e.g., services), as indicated by block 320. Moreover, the user can selectively adjust the selected indications. In response to the user's adjustments, the system may synchronously alter/adjust the resource values (e.g., offer prices) of the resources (e.g., services) to determine a median price.

Next, at block 330, the system executes the resource value construction module 210 to generate the resource value offers (e.g., offer prices) of the resources (e.g., services). Here, the system analyzes historical/previous resource value offers (e.g., previous offer prices), via the predictive resource value advisor module 213. In some instances, the generated resource value offers (e.g., offer prices) may comprise the historical/previous resource value offers (e.g., previous offer prices). The generated resource value offers (e.g., offer prices) may then be provided to the user via the display 232 so that the user can decide whether to accept the resource value offers (e.g., offer prices) from the source/supplier entities or organizations.

In some embodiments, as illustrated by block 340, the system is configured to determine a prediction of a future resource value (e.g., future price) via the predictive resource value provider module 212. Here, the predictive resource value provider module 212 is configured to receive the selected indications to determine a prediction for a future direction of the resource value offer (e.g., offer price) of the resource (e.g., service). In some embodiments, the predictive analyzer module 214 is configured to analyze the customized resource value offers (e.g., customized offer prices) and the future direction of the resource value (e.g., price) and transmit them to the user device. The user may then determine whether the customized offer prices are reasonable or the user can change the source/supplier entities which provide the resources (e.g., services).

In accordance with the steps in blocks 310-340, in some embodiments, the management module 233 is configured to provide a precision benchmarking report which comprises the competitiveness of the resource values/pricing and quality of the resource (e.g., service) levels in a category. In addition, the precision benchmarking report further comprises outlines of pricing for that resource/service under different service levels. The report may be similar to the interface 400 of the user interface module 230 illustrated by FIG. 4.

Some embodiments, may include a method performed by a computer for providing pricing information for the services. The method may comprise the steps of: providing a computer-executable platform having a resource value construction module and a data storage module to provide a supplier bid data, a contract data, an organization data, and a prior purchase data to the resource value construction module; providing a user interface having a selection module that provides the user to select an indication of the services; providing selected indications of the services by the selection module and receiving the selected indications by the resource value construction module; and analyzing the selected indications of the services to generate offer prices of the services.

In one aspect, the data storage module comprises a supplier bid data, which includes previous offer prices which a plurality of suppliers have offered to provide services.

In another aspect, the data storage module comprises a contract data module which includes contract values, spends, and terms.

In yet another aspect, the data storage module comprises an organization report data which includes reports from organizations, wherein the reports comprise current price offers with a similar service level.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s). The computer program product comprises a non-transitory computer-readable storage medium having computer-executable instructions.

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

Many alterations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments as defined by the following claims. For example, notwithstanding the fact that the elements of a claim are set forth below in a certain combination, it must be expressly understood that the embodiment includes other combinations of fewer, more or different elements, which are disclosed herein even when not initially claimed in such combinations.

Thus, specific embodiments and applications of a method for using a machine learning algorithm and a natural language processing to categorize service suppliers have been disclosed. It should be apparent, however, to those skilled in the art that many more modifications besides those already described are possible without departing from the disclosed concepts herein. The disclosed embodiments, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the embodiments. In addition, where the specification and claims refer to at least one of something selected from the group consisting of A, B, C . . . and N, the text should be interpreted as requiring at least one element from the group which includes N, not A plus N, or B plus N, etc.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims, therefore, include not only the combination of elements which are literally set forth but all equivalent structure, material or acts for performing substantially the same function in substantially the same way to obtain substantially the same result. In this sense, it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub combination or variation of a sub combination.

What is claimed is:

1. A computer system for analyzing information of resources, comprising:
a computer-executable platform comprising a resource value construction module that is structured to access a data storage module and determine a resource value offer of the resource;
a Bayesian network connected to the computer-executable platform; and
a user interface connected to the Bayesian network, the user interface comprising:
a selection module that is structured to receive a user section of an indication of resource; and
a management module that allows the user to manage the information of the resources via the user interface.

2. The computer system, as recited in claim 1, wherein the data storage module comprises a supplier bid data which includes previous resource value offers which a plurality of source entities have offered to provide resources.

3. The computer system, as recited in claim 2, wherein the data storage module comprises a contract data module which includes contract values, spends, and terms.

4. The computer system, as recited in claim 3, wherein the data storage module comprises an organization report data which includes reports from organizations, wherein the reports comprise current resource value offers with the similar resource level.

5. The computer system, as recited in claim 4, wherein the data storage module comprises prior purchase date, which includes the previous resource value offers of the resources that were provided by a plurality of source entities.

6. The computer system, as recited in claim 5, wherein the selection module is structured to receive a customized resource value offer from the user, which is analyzed by the predictive module.

7. The computer system, as recited in claim 6, wherein the resource value construction module comprises a resource value construction module that is structured to determine a prediction for a future direction of the resource value offer of the resource.

8. The computer system, as recited in claim 7, wherein the resource value construction module comprises a predictive analyzer module that analyzes customized resource value offers and the future direction of the resource value offers.

9. The computer system, as recited in claim 7, wherein the resource value construction module comprises a predictive advisor module that analyzes the previous resource value offers and the resource value offers so that the user can decide whether to accept the resource value offers from the source entities or the organizations.

10. A method performed by a computer for providing pricing information for resources, the method comprising:
providing a computer-executable platform having a resource value construction module and a data storage module structured to provide a supplier bid data, a contract data, an organization data, and a prior purchase data to the resource value construction module;
providing a user interface having a selection module that is structured to receive user selections of indications of the resources;
receiving the selected indications of the resources from the selection module and transmitting the selected indications to the resource value construction module, and
analyzing the selected indications of the resources to generate resource value offers of the resources.

11. The method of claim 10, wherein the data storage module comprises a supplier bid data which includes previous resource value offers which a plurality of source entities have offered to provide resources.

12. The method of claim 10, wherein the data storage module comprises a contract data module which includes contract values, spends, and terms.

13. The method of claim 10, wherein the data storage module comprises an organization report data which includes reports from organizations, wherein the reports comprise resource value offers with the similar resource level.

14. The method of claim 10, wherein the data storage module comprises prior purchase date, which includes the previous resource value offers of the resources that were provided by a plurality of source entities.

15. The method of claim 14, wherein the selection module is structured to receive a customized resource value offer from the user, which is analyzed by the predictive module.

16. The method of claim 14, wherein the resource value construction module comprises a resource value construction module that is structured to determine a prediction for a future direction of the resource value offer of the resource.

17. The method of claim 14, wherein the resource value construction module comprises a predictive analyzer module that analyzes customized resource value offers and the future direction of the resource value offers.

18. The method of claim 14, wherein the resource value construction module comprises a predictive advisor module that analyzes the previous resource value offers and the resource value offers so that the user can decide whether to accept the resource value offers from the source entities or the organizations.
